(19) United States
(12) Patent Application Publication
(10) Pub. No.: US 2015/0104341 A1
(43) Pub. Date: Apr. 16, 2015

(54) BYPASS VALVE, IN PARTICULAR COMPRESSOR BYPASS VALVE

(71) Applicant: BorgWarner Inc., Auburn Hills, MI (US)

(72) Inventors: Matthias Ruh, Offenheim (DE); Fred Maue, Schallodenbach (DE)

(73) Assignee: BorgWarner Inc., Auburn Hills, MI (US)

(21) Appl. No.: 14/397,771

(22) PCT Filed: Apr. 22, 2013
(86) PCT No.: PCT/US2013/037543

§ 371 Date: Oct. 29, 2014

(30) Foreign Application Priority Data
May 3, 2012 (DE) 102012008964.3

(51) Int. Cl. F04D 27/02; F04D 17/10; F16K 15/02; F02B 37/12

(52) U.S. Cl. CPC F04D 27/0215; F02B 37/127; F04D 17/10; F16K 15/026
USPC 417/440; 415/144; 137/528

(57) ABSTRACT

A bypass valve (1), in particular a compressor bypass valve, having a valve housing (2); a valve guide body (3), which is fixed in the valve housing (2); and a valve disk (4), which is guided between a closed position and an open position by the valve guide body (3) in the valve housing (2). The the valve guide body (3) and the valve disk (4) are in the form of plastic parts.

The invention relates to a bypass valve, in particular a compressor bypass valve, according to the preamble of claim 1.

A bypass valve of this type is known from EP 640 584 B1.

The fact that the displacer body of this known bypass valve is manufactured from light metal or a light metal alloy gives rise to the problem of a relatively high number of parts and therefore to the problem of a high production outlay.

It is therefore an object of the present invention to provide a bypass valve of the type indicated in the preamble of claim 1, the structure of which is simplified and makes a flow-optimized design possible.

This object is achieved by the features of claim 1.

Compared to known bypass valves, it is possible according to the invention to roughly halve the number of components for constructing the bypass valve according to the invention.

Furthermore, it is advantageous that an assembly securing element and a guide rod can be integrated in the valve disk.

The geometry of the guide rod can in this case avoid rotation of the valve disk during operation and increases the durability. Furthermore, it is possible, by providing a special geometry of the valve guide body and of the valve disk, to make it possible to coordinate the play of these two components.

Furthermore, it is advantageous that, by designing the valve guide body and the valve disk as plastic parts, machining can be dispensed with, particularly if these components are formed as plastic injection-molded components.

Finally, it is possible, by providing an overlap of the valve disk and the valve guide body in the entire shift travel, to eliminate the gap between these components which is disruptive to flow and is present in the case of known bypass valves.

A further particular advantage which is to be mentioned is that a sealing ring, in particular in the form of an O-ring, can be molded onto the valve disk, and therefore it is possible to avoid the need to install a separate O-ring in a corresponding groove of the valve disk.

Further details, advantages and features of the present invention become apparent from the following description of exemplary embodiments with reference to the drawing, in which:

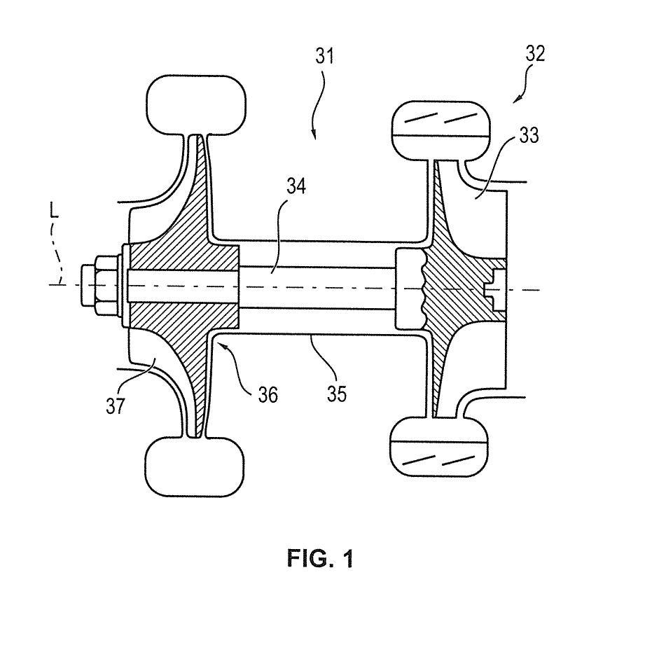

FIG. 1 shows a schematically greatly simplified illustration of an exhaust-gas turbocharger, in which a bypass valve according to the invention can be used,

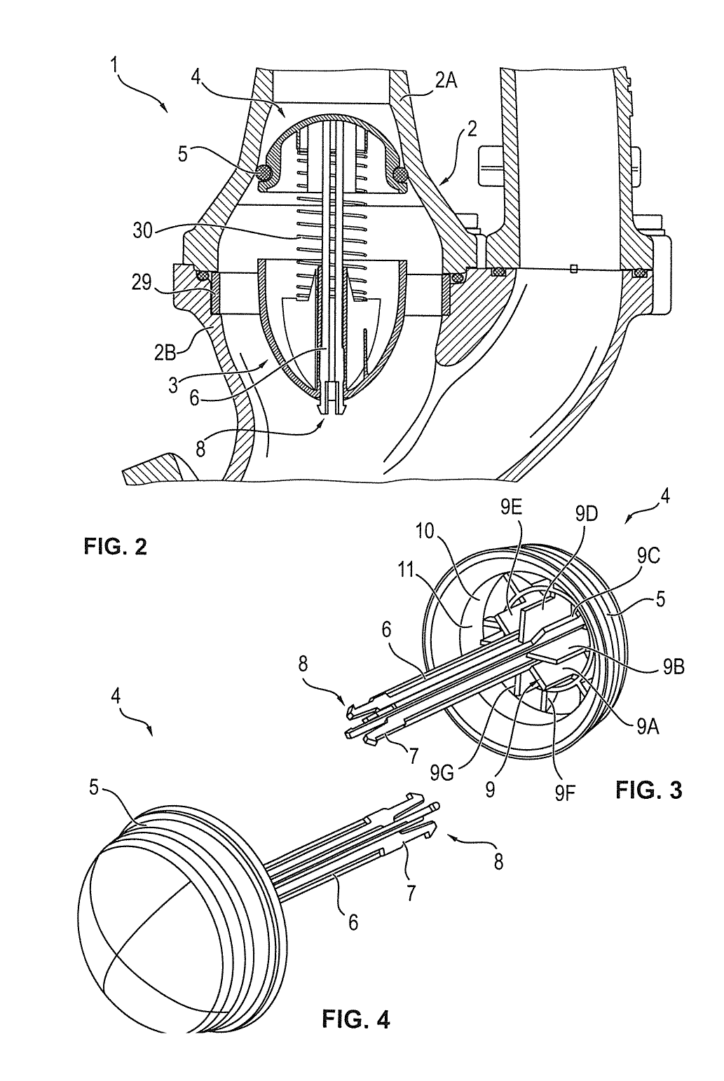

FIG. 2 shows a schematically greatly simplified basic illustration of one embodiment of the bypass valve according to the invention,

FIGS. 3 and 4 show perspective front and rear views of a valve disk of the bypass valve according to the invention,

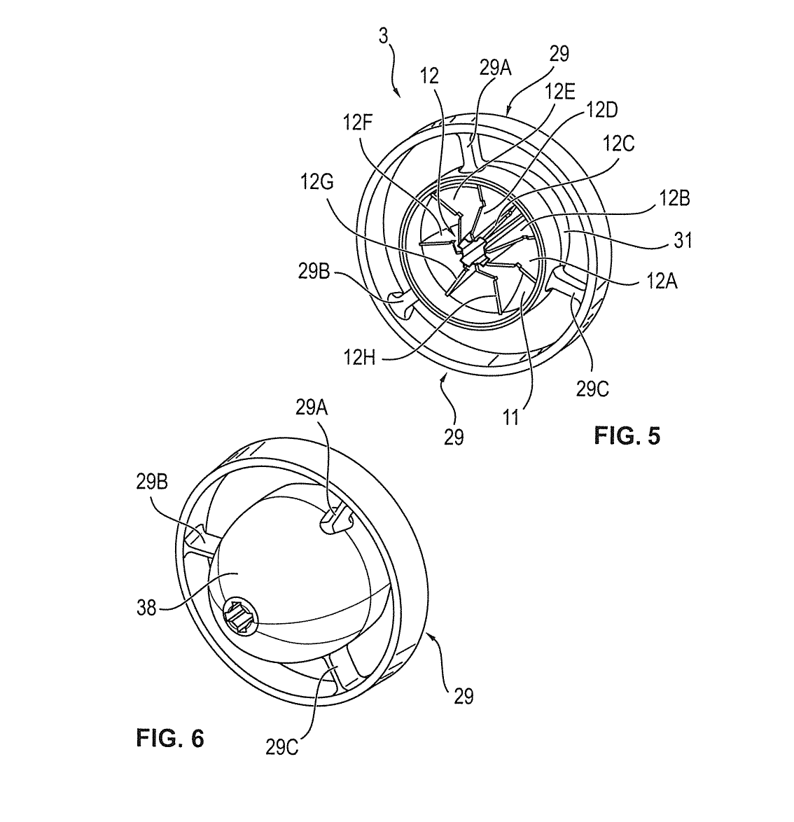

FIGS. 5 and 6 show illustrations, corresponding to FIGS. 3 and 4, of a valve guide body of the bypass valve according to the invention,

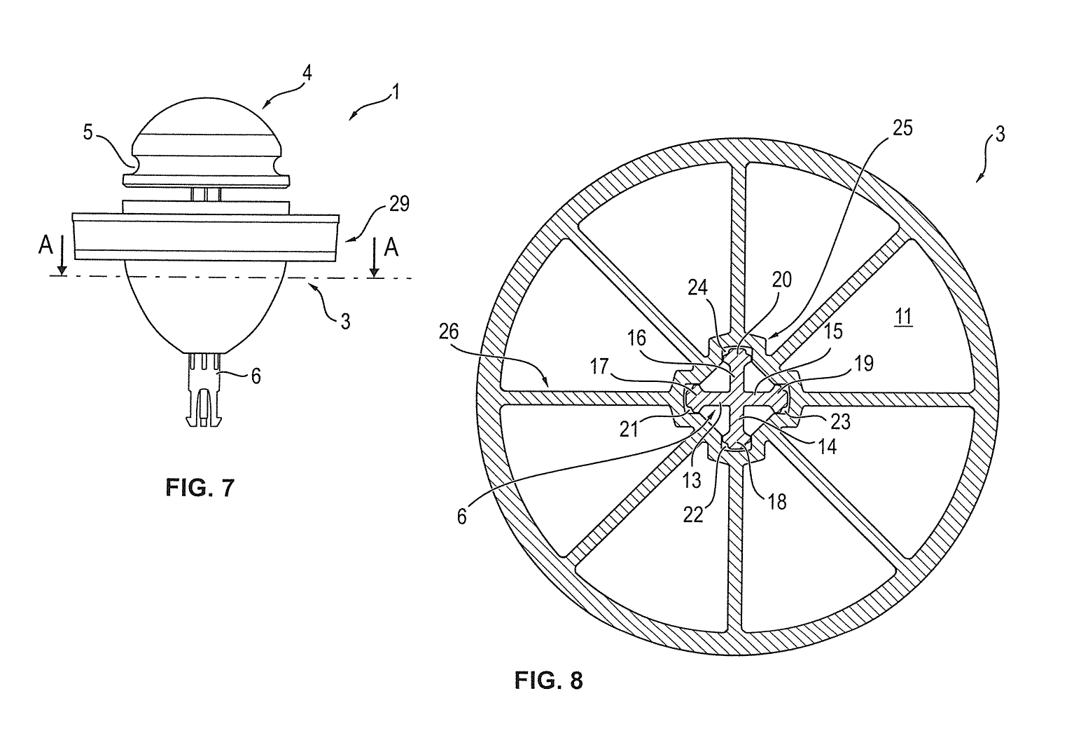

FIG. 7 shows an illustration, corresponding to FIG. 1, of the bypass valve according to the invention, in which the valve housing has been omitted to simplify the illustration,

FIG. 8 shows a sectional illustration along the line A-A shown in FIG. 7,

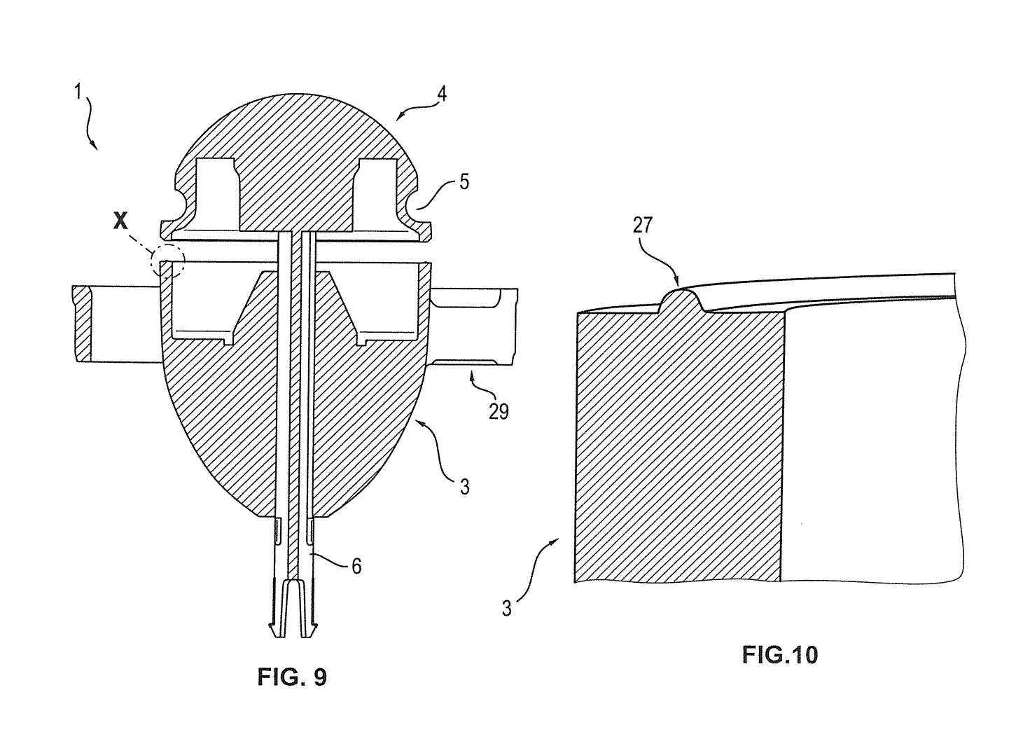

FIG. 9 shows a further embodiment, corresponding to FIG. 7, of the bypass valve according to the invention,

FIG. 10 shows an enlarged illustration of the detail X as shown in FIG. 9, and

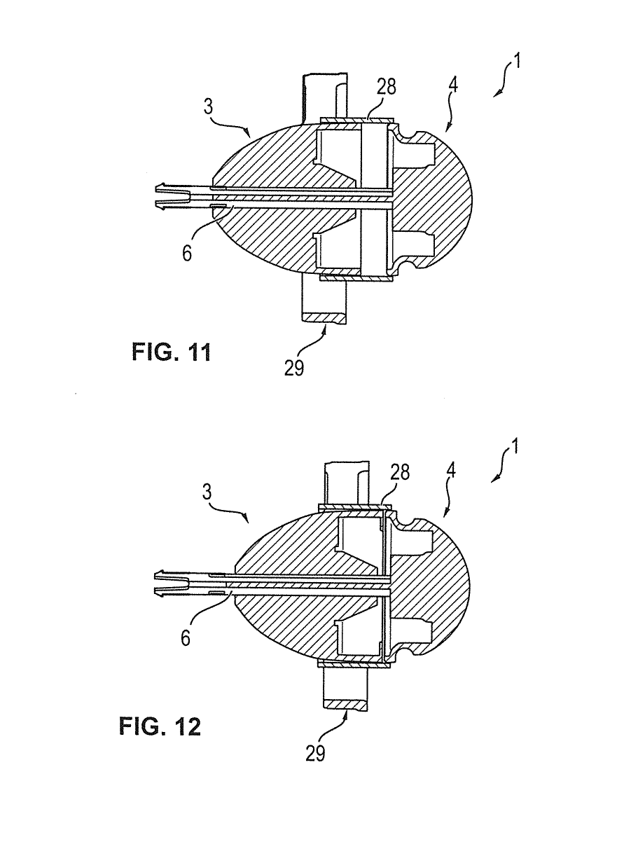

FIGS. 11 and 12 show sectional illustrations of a further embodiment of the bypass valve according to the invention in a closed and open position.

FIG. 1 shows a schematically greatly simplified basic illustration of an exhaust-gas turbocharger 31, which can be provided with a bypass valve, in particular in the form of a compressor bypass valve, which is to be described hereinbelow with reference to FIGS. 2 to 12.

As is customary, the exhaust-gas turbocharger has a turbine 32 with a turbine wheel 33, a compressor 36 with a compressor wheel 37 and a bearing housing 35 for a rotor 34, at the two end regions of which the turbine wheel 33 and, respectively, the compressor wheel 37 are fastened.

FIG. 2 shows a schematically greatly simplified basic illustration of a first embodiment of the bypass valve 1 according to the invention. The bypass valve 1 has a valve housing 2. In the valve housing 2, provision is made of a valve guide body 3, which has a circumferential retaining collar 29 which can be clamped in between the housing halves 2A and 2B of the valve housing 2.

Provision is also made of a valve disk 4, which is likewise arranged in the valve housing 2 and is guided in the valve guide body 3. In this respect, the valve disk 4 can be moved between a closed position and an open position. The valve disk 4 and the valve guide body 3, which can also be referred to as the first and second displacer parts, respectively have a semicircular (valve disk 4) and semi-oval (valve guide body 3) form which is beneficial to flow. Between the valve disk 4 and the valve guide body 3 there is arranged a spring 30. For guiding the valve disk 4 in the valve guide body 3, the valve disk 4 has an integrated guide rod 6, which will be described in detail hereinbelow.

FIG. 3 shows a view of an inner space 10 of the valve disk 4. As FIG. 3 shows, the valve disk 4 is accordingly in the form of a hollow body, with a spring guide device 9 for the spring 30 being provided in the inner space thereof. This spring guide device 9 has a plurality of integrated or cast-on guide webs. In total, in the example shown provision is made of eight such guide webs for the spring 30, of which only the guide webs 9A to 9G are visible on account of the illustration chosen in FIG. 3, however.

FIG. 3 also shows that the guide rod 6 is connected to the valve disk 4 in one piece by way of the spring guide device 9. The free end 7 of the guide rod 6 is provided with an assembly securing device 8, which comprises a plurality of hook-like portions.

The view shown in FIG. 4 again shows the form of the valve disk 4, which is approximately semicircular in the example and is beneficial to flow, with a groove 5 into which an O-ring can be inserted. As an alternative to this, an O-ring of this type can also be integrally formed on the valve disk 4 as the latter is being injection molded.

FIGS. 5 and 6 show illustrations of the valve guide body 3 which correspond to those in FIGS. 3 and 4.

Accordingly, it can be gathered from FIG. 5 that the valve guide body 3, too, is a hollow body with an inner space 11, in which a spring guide device 12 is arranged. The spring guide device 12, too, has a plurality of guide webs 12A to 12H, which are arranged circumferentially at identical intervals.

FIGS. 5 and 6 also show that the valve guide body 3 has a centrically arranged main body 38, which has the approximately semi-oval form beneficial to flow and is provided with the inner space 11.

By way of connecting webs 29A to 29C, this main body 38 is provided with the annular retaining collar 29, which can be clamped in between the housing halves 2A and 2B.

It can be seen from FIG. 8, which shows a section along the line A-A shown in FIG. 7, that the guide rod 6 has a cruciform cross section with free end regions 13, 14, 15 and 16. Transverse ribs 17, 18, 19 and 20 are integrally formed respectively on these end regions 13 to 16 and engage into rectangular recesses 21, 22, 23 and 24, as is evident in detail from the sectional illustration shown in FIG. 8. This arrangement makes it possible to compensate the play between the valve guide body 3 and, by way of the cruciform guide rod 6, the valve disk 4.

FIG. 8 also shows that the receiving recesses 21 to 24 are part of a guide tube 25, which is arranged in the inner space 11 of the valve guide body 3 by way of a holding rib arrangement 26 (constructed in the example shown from eight holding ribs arranged at identical angular intervals).

A joint consideration of FIGS. 9 and 10 reveals an annular guide projection 27, which is arranged on the valve guide body 3 and lies on a plane of the valve disk 4. This gives rise to the advantage that there is linear contact between the valve disk 4 and the valve guide body 3, which counteracts adherence particularly in the case of relatively long operation under full load.

A joint consideration of FIGS. 11 and 12 finally reveals a lengthened section 28, which can be either a lengthened valve disk section or a lengthened valve guide body section. This lengthened section 28 gives rise to an overlap between the components 3 and 4, and therefore a gap between these components 3, 4 which is disruptive to flow is prevented.

In addition to the above written disclosure of the invention, reference is hereby explicitly made to the illustrative representation in FIGS. 1 to 12 to supplement the disclosure of the invention.

### LIST OF REFERENCE SIGNS

1 Bypass valve, in particular compressor bypass valve
2 Valve housing
2A, 2B Housing halves
3 Valve guide body
4 Valve disk
5 O-ring groove
6 Guide rod
7 Free end of the guide rod
8 Assembly securing device
9 Spring guide device
9A-9G Guide webs
10 Inner space
11 Inner space
12 Spring guide device
12A-12H Guide webs
13-16 End portions
17-20 Ribs
21-24 Receiving recesses
25 Guide tube
26 Holding rib arrangement
27 Guide projection
28 Lengthened section
29 Retaining collar
30 Spring
31 Exhaust-gas turbocharger
32 Compressor
33 Compressor wheel
34 Rotor/Charger furrow
35 Bearing housing
36 Compressor
37 Compressor wheel
38 Main body
L Charger longitudinal axis

1. A compressor comprising a bypass valve (1), the bypass valve comprising
a valve housing (2);
a valve guide body (3), which is fixed in the valve housing (2); and
a valve disk (4), which is guided between a closed position and an open position by the valve guide body (3) in the valve housing (2), wherein
the valve guide body (3) and the valve disk (4) are plastic parts.

2. The compressor as claimed in claim 1, wherein the valve disk (4) is provided with an O-ring groove (5).

3. The compressor as claimed in claim 2, wherein an O-ring is molded into the O-ring groove (5).

4. The compressor bypass as claimed in claim 1, wherein the valve disk (4) has a cast-in guide rod (6).

5. The compressor as claimed in claim 4, wherein the free end (7) of the guide rod (6) is provided with an assembly securing device (8), which is cast onto the guide rod (6).

6. The compressor as claimed in claim 1, wherein a spring guide device (9) is provided in an inner space (10) of the valve disk (4).

7. The compressor valve as claimed in claim 6, wherein the spring guide device (9) has a plurality of cast-on guide webs (9A-9G).

8. The compressor as claimed in claim 1, wherein a spring guide device (12) is arranged in an inner space (11) of the valve guide body (3).

9. The compressor as claimed in claim 8, wherein the spring guide device (12) has a plurality of cast-on guide webs (12A-12H).

10. The compressor as claimed in claim 1, wherein the guide rod (6) is formed with a cruciform cross section and, at the four free end regions (13-16) thereof, has ribs (17-20) which engage into receiving recesses (21-24) in a guide tube (25).

11. The compressor as claimed in claim 10, wherein the guide tube (25) is arranged centrically in the inner space (11) of the valve guide body (3) by way of a holding rib arrangement (26).

12. The compressor as claimed in claim 1, wherein an annular guide projection (27) is provided on the valve guide body (3).

13. The compressor as claimed in claim 1, wherein the valve disk (4) is provided with a lengthened valve disk section (28).

14. The compressor as claimed in claim 1, wherein the valve guide body (3) is provided with a lengthened valve guide body section (28).

15. The compressor as claimed in claim 1, wherein the valve guide body (3) is provided with a circumferentially protruding retaining collar (29).

16. The compressor as claimed in claim 1, wherein the compressor is a turbocharger compressor.

17. A bypass valve (1), the bypass valve having:
a valve housing (2);
a valve guide body (3), which is fixed in the valve housing (2); and
a valve disk (4), which is guided between a closed position and an open position by the valve guide body (3) in the valve housing (2), wherein
the valve guide body (3) and the valve disk (4) are plastic parts.
